(19) United States
(12) Patent Application Publication
(10) Pub. No.: US 2015/0187392 A1
(43) Pub. Date: Jul. 2, 2015

(54) MOUNTING APPARATUS FOR HARD DISK DRIVE

(71) Applicant: HON HAI PRECISION INDUSTRY CO., LTD., New Taipei (TW)

(72) Inventor: ZHENG-HENG SUN, New Taipei (TW)

(73) Assignee: HON HAI PRECISION INDUSTRY CO., LTD., New Taipei (TW)

(21) Appl. No.: 14/221,297

(22) Filed: Mar. 21, 2014

(30) Foreign Application Priority Data
Dec. 26, 2013 (CN) 2013107297940

(51) Int. Cl. G11B 33/12

(52) U.S. Cl. CPC G11B 33/123

(57) ABSTRACT

A mounting apparatus for a hard disk drive (HDD) includes a rack and two resilient brackets. The rack defines a receiving slot and two latching holes located at rear end of the receiving slot. Each bracket includes a shell fitted about the HDD, a positioning plate protruding from the rear of the shell, and a tab protruding out from the positioning plate. A combination of the HDD and the brackets is received in the receiving slot, and the tabs are detachably latched to the corresponding latching holes of the rack.

### FIELD

The present disclosure relates to mounting apparatus, and particularly to a mounting apparatus for hard disk drives (HDDs).

### BACKGROUND

Mounting an HDD in a computer chassis generally involves placing the HDD in a holding area of a drive bracket. A number of screws are screwed through side walls of the drive bracket into two sides of the HDD to fasten the HDD on the drive bracket, Then mounting the HDD and the bracket in a computer chassis or a mobile HDD rack. For proper balanced installation of the HDD, multiple screws should be fastened at the same time, making installation and removal of the HDD tedious.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an embodiment of a mounting apparatus for mounting a hard disk drive (HDD), wherein the mounting apparatus includes two brackets.

FIG. 2 is an enlarged view of one of the brackets of FIG. 1.

FIGS. 3 and 4 are isometric views of the process of assembling the HDD of FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

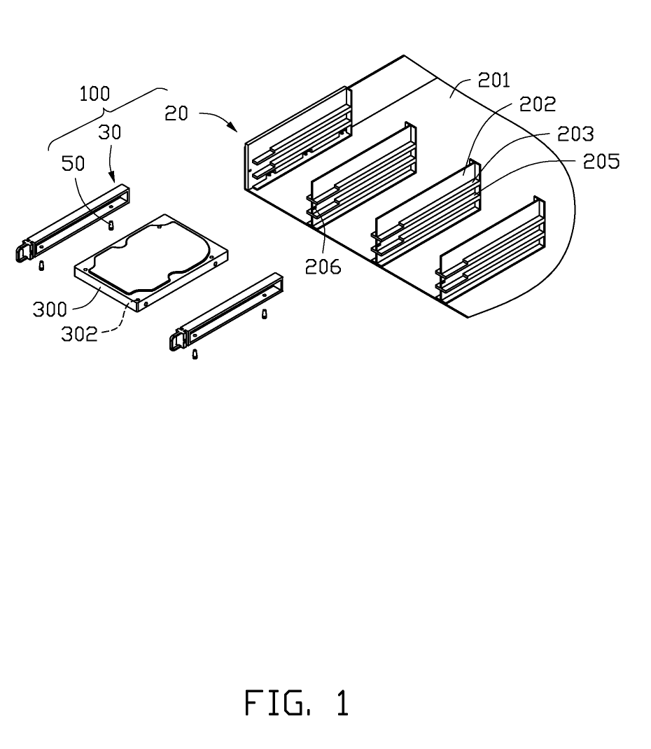

FIG. 1 shows an embodiment of a mounting apparatus 100 for a hard disk drive (HDD) 300 The mounting apparatus 100 comprises a rack 20 for receiving the HDD 300, two brackets 30, and a plurality of fasteners 50. Two opposite sides of a bottom surface define a plurality of mounting holes 302.

The rack 20 comprises a bottom plate 201 and a plurality of the supporting plates 202 perpendicularly mounted on the bottom plate 201. The supporting plates 202 are spaced from and parallel to each other. A plurality of spaced bars 203 protrudes from every two adjacent supporting plates 202 toward each other. The adjacent supporting plates 202 and the corresponding bars 203 cooperatively bound a plurality of receiving slots 205 substantially parallel to each other. Each supporting plate 202 defines a latching hole 206 located at a rear end of each receiving slot 205.

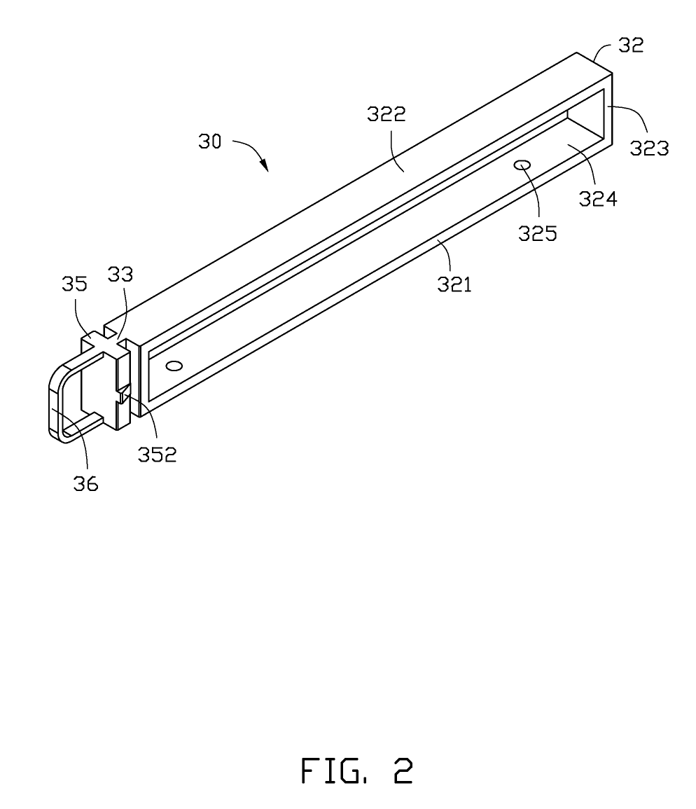

FIG. 2 shows one of the brackets 30 comprises a rectangular and resilient shell 32, a resilient connecting plate 33 protruding rearward from a rear end of the shell 32, a position plate 35 perpendicularly mounted a rear end of the connecting plate 33. In addition, a C-shaped operation portion 36 protruding rearward from the position plate 35 opposite to the connecting plate 33. The shell 32 comprises a bottom plate 321, a top plate 322 opposite to the bottom plate 321, and two end plates 323 connecting the bottom plate 321 and the top plate 322. The bottom plate 321, the top plate 322, and the end plates 323 cooperatively bound a receiving space 324. Two opposite ends of the bottom plate 321 define two through holes 325. A wedge-shaped tab 352 protrudes out from a side of the position plate 35. In the embodiment, the bracket 30 is made of resilient material, such as plastic.

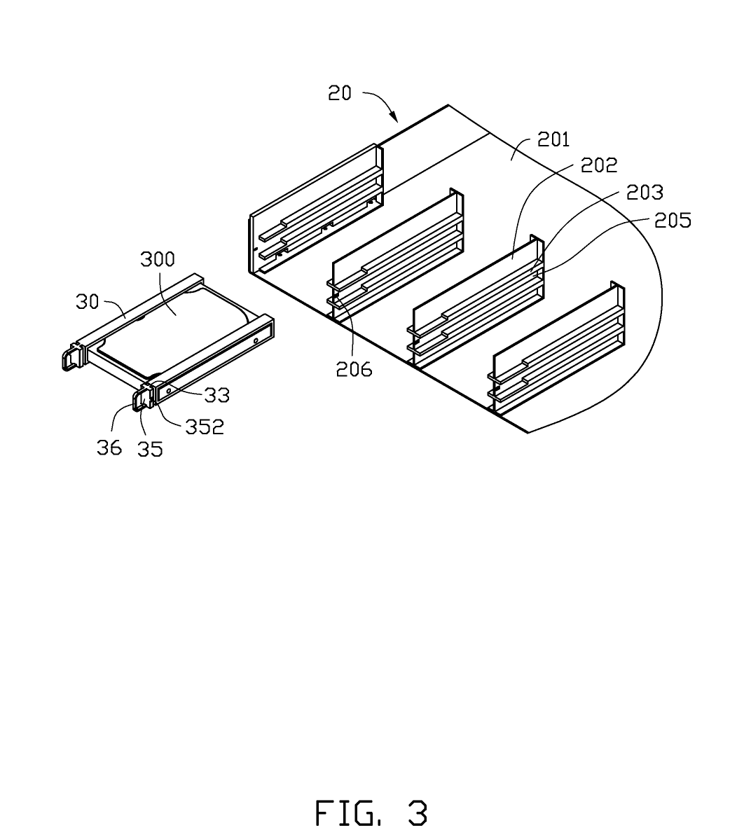

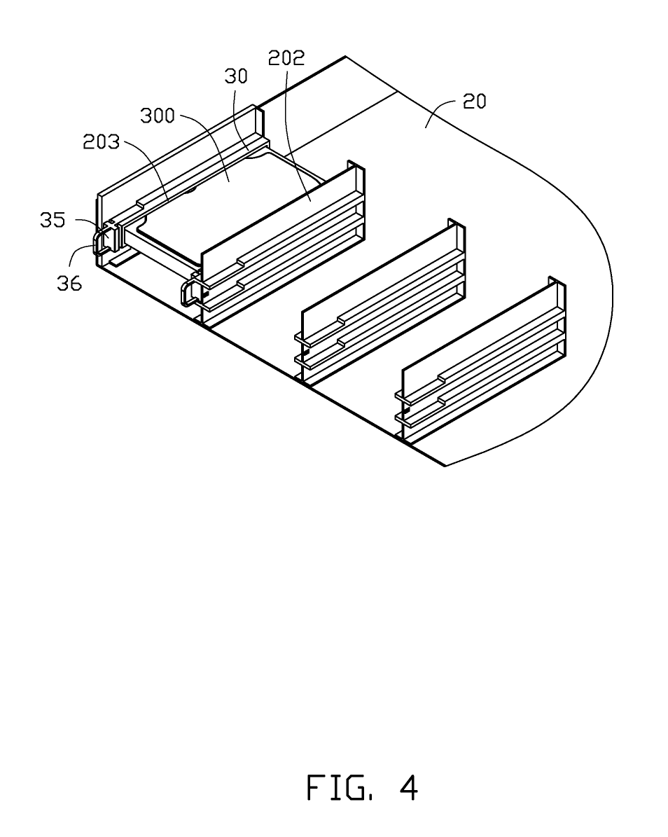

FIGS. 3 and 4 show that in use, two brackets 30 are located at two opposite sides of the HDD 300, with the tabs 352 away from each other. Two opposite sides of the HDD 300 are inserted into the receiving spaces 324 of the brackets 30, to deform the shells 32. The mounting holes 302 are aligned with the through holes 325 of the brackets 30. The fasteners 50 extend through the through holes 325, to be latched in the corresponding mounting holes 302. A front end of a combination of the HDD 300 and the brackets 30 is inserted in the corresponding receiving slot 205 from the ends of the supporting plates 202. The tabs 352 slidably abut against the corresponding supporting plates 202, to deform the connecting plates 33. When the tabs 352 align with the corresponding latching holes 206, the connecting plates 33 are restored to urge the tabs 352 to latch in the latching holes 206.

When disengaging the HDD 300 from the rack 20, the operation portions 36 are pressed toward each other, to deform the connecting pates 33. The tabs 352 are disengaged from the corresponding latching holes 206. The combination of the HDD 300 and the brackets 30 is pulled rearward from the rack 20, to fully disengage from the supporting plates 202.

In another embodiment, the fasteners 50 can be omitted, and the shell 32 is firmly fitted about the HDD 300.

In still another embodiment, the fasteners 50 and the corresponding bracket 30 are integrally formed.

Even though numerous characteristics and advantages of the embodiments have been set forth in the foregoing description, together with details of the structure and function of the embodiments, the present disclosure is illustrative only, and changes may be made in detail, especially in the matters of shape, size, and arrangement of parts within the principles of the embodiments to the full extent indicated by the broad general meaning of the terms in which the appended claims are expressed.

What is claimed is:

1. A mounting apparatus for a hard disk drive (HDD), comprising:
a rack defining a receiving slot and two latching holes located at a rear end of the receiving slot; and
two resilient brackets for being mounted at two opposite sides of the HDD, wherein, when mounting the HDD, each of the resilient brackets comprises a shell fitted about the HDD, a positioning plate protruding rearward from the shell, and a tab protruding out from the positioning plate, a combination of the HDD and the brackets is received in the receiving slot, and the tabs are detachably latched to the corresponding latching holes of the rack.

2. The mounting apparatus of claim 1, wherein the shell comprises a bottom plate, a top plate opposite to the bottom plate, and two end plates connecting the top plate, and the bottom plate, the top plate, and the end plates cooperatively bound a receiving space for receiving the HDD.

3. The mounting apparatus of claim 2, wherein two opposite ends of the bottom plate define two through hole, and a plurality of fasteners extend through the bracket to latch the HDD.

4. The mounting apparatus of claim 1, wherein the rack comprises a bottom plate, two spaced supporting plates mounted on the bottom plate, and a plurality of spaced bars protrude from the supporting plates toward each other, the supporting plates and the bars cooperatively bound the receiving slots parallel to each other, and the latching holes are defined in rear ends of the supporting plates and communicated with the corresponding receiving slots.

5. The mounting apparatus of claim 1, wherein each bracket further comprises a resilient connecting plate connected between the positioning plate and the shell.

6. The mounting apparatus of claim 1, wherein each bracket further comprises an operation portion protruding rearward from the positioning plate opposite to the shell.

7. The mounting apparatus of claim 1, wherein each bracket is made of plastic.
